(19) United States
(12) Patent Application Publication
(10) Pub. No.: US 2024/0083412 A1
(43) Pub. Date: Mar. 14, 2024

(54) HYBRID ELECTRIC VEHICLE AND METHOD OF CONTROLLING ENGINE STOP FOR THE SAME

(71) Applicants: HYUNDAI MOTOR COMPANY, Seoul (KR); KIA CORPORATION, Seoul (KR)

(72) Inventors: Hyun Jin Park, Busan (KR); Seo Ho Lee, Hwaseong-si (KR); Jae Young Choi, Seoul (KR); Kwon Chae Chung, Seoul (KR)

(73) Assignees: HYUNDAI MOTOR COMPANY, Seoul (KR); KIA CORPORATION, Seoul (KR)

(21) Appl. No.: 18/101,420

(22) Filed: Jan. 25, 2023

(30) Foreign Application Priority Data
Sep. 13, 2022 (KR) 10-2022-0115111

(51) Int. Cl. B60W 20/40; B60W 10/06; B60W 10/08

(52) U.S. Cl. CPC B60W 20/40; B60W 10/06; B60W 10/08; B60W 2510/0623; B60W 2510/0638; B60W 2710/083

(57) ABSTRACT

Disclosed is a hybrid electric vehicle and a method of controlling an engine stop for the vehicle. The method includes: determining whether a first condition and a second condition is satisfied; applying a negative torque to the motor when the first condition and the second condition are satisfied; predicting occurrence of reverse rotation of the engine; and applying a feedback torque for satisfying the target behavior of the engine to the motor when the occurrence of the reverse rotation is predicted.

### CROSS REFERENCE TO RELATED APPLICATION

The present application claims priority to Korean Patent Application No. 10-2022-0115111, filed on Sep. 13, 2022, the entire contents of which are incorporated herein by reference.

### FIELD

The present disclosure relates to a hybrid electric vehicle and a method of controlling an engine stop for the hybrid electric vehicle.

### BACKGROUND

The statements in this section merely provide background information related to the present disclosure and may not constitute prior art.

As interest in the environment has increased recently, the trend for an eco-friendly vehicle equipped with an electric motor as a driving source also increases. Eco-friendly vehicles are referred to as electrified vehicles and can be exemplified as hybrid electric vehicles (HEV) or electric vehicles (EV). Here, hybrid electric vehicles generally denote vehicles capable of using a plurality of driving sources, including the engine and motor.

In the case of such hybrid electric vehicles, since the engine and motor are provided together, the engine can be stopped by outputting the torque, so-called the negative torque, which rotates in the opposite direction to the rotational direction of the engine through the motor that is always connected to the engine, instead of stopping the engine due to the energy loss through the frictional force.

In the engine stopping process described above, the motor may recover rotational energy maintained by the inertia of the engine after stopping fuel injection. The recovered energy may improve the efficiency of the vehicle used in battery charging of the vehicle.

However, as the amount of motor torque increases, the rotational speed of the engine decreases rapidly, and the possibility of the engine being designed to rotate in one direction may increase.

Accordingly, there is a need for propose a measure to respond to the reverse rotation of the engine while maximally securing the battery charge amount and the speed of passing the resonance region.

### SUMMARY

The present disclosure provides a hybrid electric vehicle and a method for controlling engine stop for the same capable of responding to reverse engine rotation while efficiently recovering rotational energy maintained by the inertia of the engine during the engine stop process through a motor. The motor is directly connected to the engine and always rotates with the engine.

According to one aspect of the present disclosure, a method for controlling an engine stop of a hybrid electric vehicle includes:
determining, when an engine stop request is generated, whether a first condition for stopping the engine and a second condition for the engine rotational energy recovery of a motor are satisfied; when the first condition and the second condition are satisfied, applying a negative torque to the motor, which is determined based on the rotational speed of the engine determined by a detection result of at least one sensor and a predetermined first target rotational speed; predicting an occurrence of reverse rotation of the engine based on the rotational speed of the engine determined through the sensor; and when the reverse rotation is predicted, applying a feedback torque for satisfying the target behavior of the engine to the motor.

For example, the rotational speed of the engine may be determined based on a detection result of a first sensor detecting the position of a rotor of the motor.

For example, the rotational speed of the engine may be determined by further considering the detection result of a second sensor detecting a crank shaft rotation of the engine.

For example, the negative torque may be determined to correspond to an absolute value of a difference between the rotational speed of the engine and the target rotational speed. In other words, the greater the absolute value of the difference is, the greater the negative torque is. Whereas when the absolute value is relatively small, the negative torque becomes small accordingly.

In one embodiment, the negative torque may be determined by considering at least one of a predetermined maximum value and a predetermined variance limit per hour.

In another embodiment, predicting the reverse rotation of the engine may include predicting the reverse rotation of the engine based on the predetermined target angular acceleration to correspond to the rotational speed of the engine considering the reverse rotation of the engine and the angular acceleration according to changes in the rotational speed of the engine.

In one embodiment, whether the first condition is satisfied may be determined based on at least one of an engine clutch state, a powertrain mode, or whether a fuel injection request is generated.

In one embodiment, whether the second condition is satisfied may be determined based on at least one of the rotational speed of the engine, a battery state, or whether the sensor is normally operating.

In one embodiment, when the rotational speed of the engine is less than a predetermined second target rotational speed, a positive torque may be applied to the motor so that the rotational speed of the engine is satisfied with the predetermined second target rotational speed.

According to another aspect of the present disclosure, a hybrid electric vehicle includes: an engine; a motor directly connected to the engine; and a control unit. In particular, the control unit is configured to determine, when an engine stop request is generated, whether a first condition for stopping the engine and a second condition for the engine rotational energy recovery of the motor are satisfied. The motor is connected to the engine. When the first condition and the second condition are satisfied, the control unit applies a negative torque to the motor. The negative torque is determined based on the rotational speed of the engine detected by at least one sensor and a predetermined first target rotational speed. In addition, the control unit is configured to predict an occurrence of reverse rotation of the engine based on the engine rotational speed of the engine determined through the sensor, and apply a feedback torque to the motor to satisfy the target behavior of the engine when the reverse rotation is predicted.

In one embodiment, the rotational speed of the engine may be determined by a first sensor detecting a position of a rotor of the motor.

In another embodiment, the rotational speed of the engine may be determined based on a detection result of a second sensor detecting a crankshaft rotation of the engine.

In one embodiment, the negative torque may increase as an absolute value of a difference between the rotational speed of the engine and the target rotational speed increases.

Similarly, when the absolute value becomes small, the negative torque becomes small accordingly.

For example, the negative torque may be determined by considering at least one of a predetermined maximum value and a predetermined variance limit per hour.

For example, the control unit may predict the reverse rotation of the engine based on the predetermined target angular acceleration to correspond to the rotational speed of the engine considering the occurrence of the reverse rotation of the engine and the angular acceleration according to changes in the rotational speed of the engine.

For example, whether the first condition is satisfied may be determined based on at least one engine clutch state, a powertrain mode, and whether a fuel injection request is generated.

For example, whether the second condition is satisfied may be determined based on at least one of the rotational speed of the engine, a battery state, or whether the sensor is normally operating.

For example, in the case the rotational speed of the engine is less than a predetermined second target rotational speed, the control unit may apply a positive torque to the motor so that the rotational speed of the engine is satisfied with the predetermined second target rotational speed.

According to various embodiments of the present disclosure as described above, the motor torque for the rotational energy recovery may be improved through controlling the engine stop during the engine stop process.

Therefore, the amount of battery charge may be increased, thereby improving fuel efficiency, allowing the engine to be stopped quickly, and reducing the vibration during the engine stop process.

In particular, by predicting the reverse rotation of the engine more accurately, the reverse rotation may be mitigated while improving the efficiency of the engine stop control.

Advantages which may be obtained in this specification are not limited to the aforementioned advantages, and various other advantages may be evidently understood by those having ordinary skill in the art to which the present disclosure pertains from the following description.

### BRIEF DESCRIPTION OF THE DRAWINGS

In order that the disclosure may be well understood, there will now be described various forms thereof, given by way of example, reference being made to the accompanying drawings, in which:

FIG. 1 is a block diagram illustrating a powertrain configuration of a hybrid electric vehicle according to an embodiment of the present disclosure;

FIG. 2 is a block diagram illustrating a control system of a hybrid electric vehicle according to an embodiment of the present disclosure;

FIG. 3 illustrates an engine stop control by an engine stop control unit of a hybrid electric vehicle according to an embodiment of the present disclosure;

FIG. 4 is a diagram describing an example of a form in which an engine stop control is performed according to an embodiment of the present disclosure;

FIG. 5 is a diagram for describing an example of a form in which engine reverse rotation prevention control is performed according to an embodiment of the present disclosure;

FIG. 6 is a diagram for describing an example of a form in which engine reverse rotation correspondence control is performed according to an embodiment of the present disclosure; and

FIG. 7 is a flowchart showing an example of an engine stop control process according to an embodiment of the present disclosure.

### DETAILED DESCRIPTION

Specific structural or functional descriptions in embodiments disclosed in the specification or application are merely for description of the some embodiments of the present disclosure, can be embodied in various forms and should not be construed as limited to the embodiments described in the specification or application.

It should be understood, however, that there is no intent to limit the present disclosure to the specific embodiments, but the intention is to cover all modifications, equivalents, and alternatives included to the scope of the present disclosure.

Unless otherwise defined, all terms including technical and scientific terms used herein have the same meaning as commonly understood by one of ordinary skill in the art to which this disclosure belongs. It should be further understood that terms, such as those defined in commonly used dictionaries, should be interpreted as having a meaning that is consistent with their meaning in the context of the relevant art and should not be interpreted in an idealized or overly formal sense unless expressly so defined herein.

Hereinafter, embodiments of the present disclosure are described in detail with reference to the accompanying drawings, in which the same or similar elements are denoted by the same reference numerals even though they are depicted in different drawings and redundant descriptions thereof are avoided.

In the following description, with respect to constituent elements used in the following description, suffixes “module” and “unit” are given in consideration of only facilitation of description and do not have meaning or functions discriminated from each other.

In terms of describing the embodiments of the present disclosure, detailed descriptions of related art are omitted when they may make the subject matter of the embodiments of the present disclosure rather unclear. In addition, the accompanying drawings are provided only for a better understanding of the embodiments of the disclosure and are not intended to limit technical ideas of the disclosure. Therefore, it should be understood that the accompanying drawings include all modifications, equivalents and substitutions within the scope and spirit of the present disclosure.

Terms such as “first” and “second” may be used to describe various components, but the components should not be limited by the above terms. In addition, the above terms are used only for the purpose of distinguishing one component from another.

When it is described that one component is “connected” or “joined” to another component, it should be understood that the one component may be directly connected or joined to another component, but additional components may be present therebetween. However, when one component is described as being “directly connected,” or “directly coupled” to another component, it should be understood that additional components may be absent between the one component and another component.

Unless the context clearly dictates otherwise, singular forms include plural forms as well. When a component, device, element, or the like of the present disclosure is described as having a purpose or performing an operation, function, or the like, the component, device, or element should be considered herein as being “configured to” meet that purpose or to perform that operation or function.

In the present application, it should be further understood that the terms “comprises,” “includes,” etc. specify the presence of stated features, integers, steps, operations, elements, components, or combinations thereof, but do not preclude the presence or addition of one or more other features, integers, steps, operations, elements, components, or combinations thereof.

Further, terms “unit” or “control unit” forming part of the names of a motor control unit (MCU), a hybrid control unit (HCU), etc. are merely terms that are widely used in the naming of a controller for controlling a specific function of a vehicle, and should not be construed as meaning a generic function unit.

For example, each controller is a communication device that communicates with other controllers or sensors to control the function that is responsible for, a memory that stores an operating system or logic commands and input and output information, and one or more processor that performs determination, calculation, decision, and the like, which is necessary for the control the function that is responsible therefor.

Prior to the description with reference to the method for controlling the engine speed according to an embodiment of the present disclosure, the structure and control system of the hybrid electric vehicle applicable to embodiments are explained first.

FIG. 1 is a block diagram illustrating a powertrain configuration of a hybrid electric vehicle according to an embodiment of the present disclosure.

Referring to FIG. 1, the powertrain of the hybrid electric vehicle includes: two motors 120 and 140, which are mounted between an internal combustion engine (ICE) 110 and an automatic transmission 150, and an engine clutch 130, which employs a parallel type of hybrid system. Such a parallel type of hybrid system is also called a transmission mounted electric drive (TMED) hybrid electric system since a motor 140 is always connected to an input side of the automatic transmission 150.

Here, the first motor 120 of the two motors 120 and 140 is disposed between the engine 110 and one end of the engine clutch 130, and an engine shaft of the engine 110 and a first motor shaft of the first motor 120 are directly connected to each other to rotate together at all times.

One end of a second motor shaft of the second motor 140 may be connected to the other end of the engine clutch 130, and the other end of the second motor shaft may be connected to the input terminal of the transmission 150.

The second motor 140 has a greater output than the first motor 120, and the second motor 140 may perform as a drive motor. In addition, the first motor 120 may perform as a starter motor to crank the engine 110 when the engine 110 starts. The power generation may be performed with the power of the engine 110 while the engine 110 is in operation. When the engine is off, the rotational energy of the engine 110 can be recovered through power generation.

In the foregoing description, the engine 110 and the motor that is rotating together always with the engine 110 may be expressed as a first motor 120 to distinguish from the second motor 140, which acts as the driving motor.

As shown in FIG. 1, when a driver depresses an accelerator pedal after starting (for example, HEV Ready), in the hybrid electric vehicle having the powertrain, the second motor 140 may be driven using the electrical power of a battery (not shown) in a state in which the engine clutch 130 is opened. Accordingly, the power of the second motor 140 passes through the automatic transmission 150 and a final drive (FD) 160 to move a wheel (i.e., EV mode). When a vehicle is gradually accelerated and a larger driving force is required, the first motor 120 may operate to crank the engine 110.

After the engine 110 is started, and when a difference in rotational speed between the engine 110 and the second motor 140 is within a predetermined range, the engine clutch 130 is engaged, and the engine 110 and the second motor 140 may be rotated together (i.e., a transition from EV mode to HEV mode). Accordingly, through a torque blending process, the output of the second motor 140 may decrease, and the output of the engine 110 may increase, so that the driver's demand torque may be satisfied. In the HEV mode, most of the demand torque may be satisfied by the engine 110. The difference between engine torque and the demand torque may be compensated through at least one of the first motor 120 or the second motor 140. For example, when the engine 110 outputs a torque higher than the demand torque considering the efficiency of the engine 110, either the first motor 120 or the second motor 140 may generate power to the extent of the redundancy of the engine torque. When the engine torque exceeds the demand torque, at least one of the first motor 120 or the second motor 140 may output the deficit torque.

A predetermined engine off condition, such as a decelerating vehicle, is satisfied, the engine clutch 130 may be opened, and the engine 110 may be stopped (i.e., a transition from HEV mode to EV mode). When decelerating, by using the driving force of the wheel, a battery may be recharged through the second motor 140, which is referred to as a braking energy regeneration or regenerative braking.

In general, the automatic transmission 150 may use a discrete variable transmission or a multiple-disc clutch, such as a dual clutch transmission (DCT).

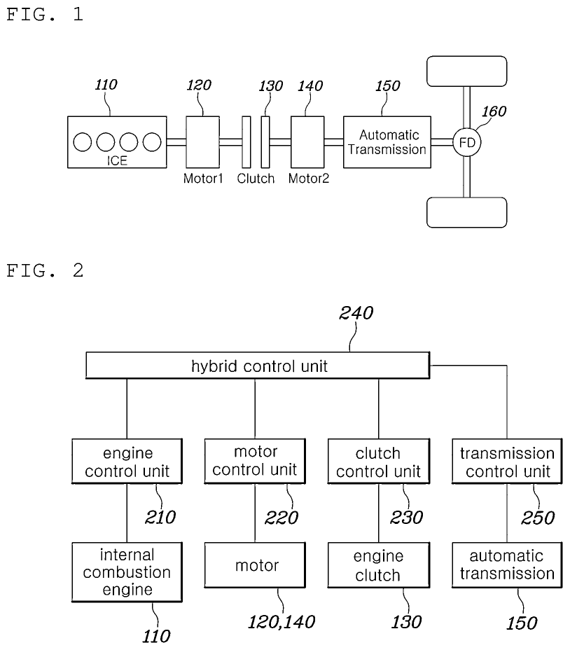

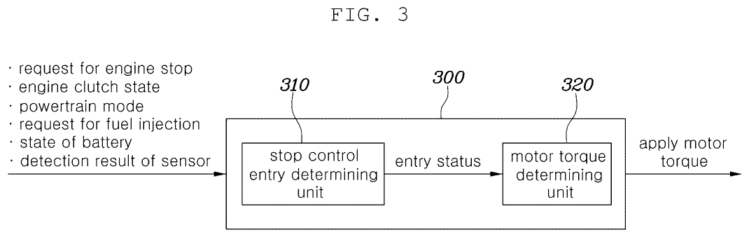

FIG. 2 illustrates a control system of a hybrid electric vehicle according to an embodiment of the present disclosure.

Referring to FIG. 2, the engine 110 of the hybrid vehicle may be controlled by an engine control unit 210, and the first motor 120 and the second motor 140 may be controlled by a motor control unit (MCU) 220. The engine clutch 130 may be controlled by a clutch control unit 230. Here, the engine control unit 210 is also referred to as an engine management system (EMS). In addition, the automatic transmission 150 may be controlled by a transmission control unit 250.

The MCU 220 transmits a pulse width modulation (PWM) control signal to a gate drive unit (not shown) based on a motor angle, phase voltage, phase current, demand torque, and the like of each of the motors 120 and 140. The gate drive unit may control an inverter (not shown) that drives each of the motors 120 and 140 accordingly.

Each control unit may be connected to a hybrid control unit (HCU) 240 that controls the overall powertrain, including a mode switching process, which is an upper-level control unit thereof, and may provide the HCU 240 with the information required to control the engine clutch when shifting gears or changing driving mode, and/or the information required to stop the engine according to the control of the HCU 240 or perform an operation according to a control signal.

For example, the HCU 240 may determine whether to perform switching between EV-HEV modes or CD-CS mode (in the case of PHEV) according to the driving state of the vehicle. To this end, the HCU 240 determines when the engine clutch 130 is opened and performs a hydraulic control when opened. In addition, the HCU 240 may determine a state (e.g., a lock-up, slip, or open state, etc.) of the engine clutch 130, and may control the timing of stopping the fuel injection of the engine 110. In addition, the HCU 240 may send a torque command for controlling the torque of the first motor 120 to the MCU 220 for an engine stop control, thereby controlling the recovery of the engine rotational energy. In addition, the HCU 240 determines the state of each of the drive sources 110, 120, and 140 to satisfy the demand torque, and determines the required drive force to be shared by each of the drive sources 110, 120, and 140 according to the respective drive source, in which the respective drive source may send the torque command to the control units 210 and 220.

Of course, it is apparent to those skilled in the art that the above-mentioned connection relationship and the function and classification of each control unit is exemplary and is non-limited by its name. For example, the HCU 240 may be implemented such that the corresponding function is provided by replacing any one of the other control units except for the same, or the corresponding function may be provided in a distributed manner in two or more of the other control units.

It is apparent to those having ordinary skill in the art that the aforementioned configurations of FIGS. 1 and 2 are only some forms of the hybrid electric vehicle, and the hybrid electric vehicle applicable to the embodiment is not limited to such a configuration.

In an embodiment of the present disclosure, it is proposed that by performing the engine stop control through the first motor 120, which is directly connected to the engine 110 and always rotates with the engine 110, the control accuracy is improved, thereby allowing a countermeasure against the reverse rotation of the engine 110 while increasing the energy recovery rate and reducing vibrations when stopping the engine.

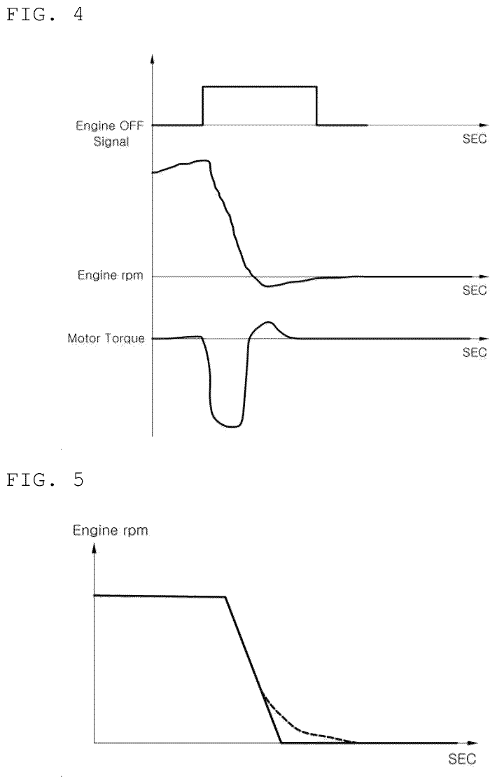

First, a configuration of an engine control unit that can perform a first torque control for the effective engine stop control according to an embodiment is explained with reference to FIG. 3.

FIG. 3 shows an engine stop control by an engine stop control unit of a hybrid electric vehicle according to an embodiment of the present disclosure.

Referring to FIG. 3, an engine-stop control unit 300, may have input information, including an engine stop request, state of the engine clutch 130, powertrain mode, fuel injection request, battery state, and sensor detection result.

Here, whether the engine stop request is generated may be determined by a driving mode input of a driver and may be obtained from either the engine control unit 230 or the HCU 240, an upper-level control unit thereof.

The state of the engine clutch 130 may include a lock-up state, a slip state, an open state, and the like, and may include not only the current state but the target state and a transition process from the current state to the target state. The state of the engine clutch 130 may be obtained from either the clutch control unit 230 or the HCU 240, an upper-level control unit thereof.

The powertrain mode may include an EV mode, an HEV mode, and the like, depending on the state of the engine 110, the motors 120 and 140, and the engine clutch 130, and the HEV mode may include the HEV-parallel mode in which the power of the engine 110 is transmitted to the wheel together with the power of the motors 120 and 140, and an HEV-series mode in which the first motor 120 charges the battery with the power of the engine 110. The powertrain mode may be obtained from the HCU 240 that controls the powertrain.

The battery state may include the state of charge (SOC), temperature and charging and discharging power limit, and the like, and obtained from a battery management system (BMS) or the HCU 240.

The detection result of sensor may include the detection result value of the sensor for determining the rotational speed of the engine 110. Here, the sensor for determining the rotational speed of the engine 110 may include a first sensor (not shown) for detecting the rotor position of the first motor 120 or a second sensor (not shown) for detecting the crankshaft rotation of the engine 110. For instance, the first sensor may be a resolver, and the second sensor may be a crankshaft position sensor.

In addition, an engine-stop control unit 300 may apply torque to the first motor 120 according to the determined result based on the input information described above. Applying torque to the engine-stop control unit 300 may be transmitted to the MCU 220 in the form of motor torque command.

In the implementation, since the engine-stop control unit 300 involves torque control of the first motor 120, it may be implemented as a function of the MCU 220 or the HCU 240, which is an upper-level control unit thereof, but this is an example and is not necessarily limited thereto.

Hereinafter, a detailed configuration of the engine-stop control unit 300 is explained.

The engine-stop control unit 300 may include a stop-control-entry determining unit 310 and a motor torque determining unit 320.

First, the stop-control-entry determining unit 310 determines whether a first condition for whether the engine 110 can be stopped when the engine stop request is generated. and a second condition for the engine rotational energy recovery of the first motor 120 that always rotates together with the engine 110, which is directly connected, are satisfied.

In this case, whether the first condition is satisfied is determined based on the state of the engine clutch 130, powertrain mode, and whether the fuel injection request is generated. For example, the stop-control-entry determining unit 310 may determine that the first condition is not satisfied when: the engine clutch 130 is not in open state, the powertrain mode is not a mode that does not require the engine 110 to start, and the fuel injection request is not generated. Here, the powertrain mode that does not require the engine 110 to start may include an EV mode, in which only the motor torque from the second motor 140 is transmitted to the wheel, and an HEV-series mode. In addition, the state of the engine clutch 130 and the powertrain mode may include not only the current state but also the target state-mode and target state-mode transition processes. For example, the stop-control-entry determining unit 310 may also consider whether the state of the target engine clutch 130 is in an open state or whether the target powertrain mode does not require the engine 110 to start. The first condition is on whether the engine 110 is capable of starting and stopping, and when the stop-control-entry determining unit 310 does not satisfy the first condition, it is considered that starting or stopping the engine 110 is impossible or inappropriate, and thus the engine stop control is not entered.

Meanwhile, whether the second condition is satisfied may be determined based on the rotational speed of the engine 110, the battery state, and whether the sensor operates normally. For example, the stop-control-entry determining unit 310 may determine that the second condition is not satisfied when: the rotational speed of the engine 110 is less than the predetermined value, the battery SOC exceeds the predetermined upper limit or is less than the lower limit, the battery temperature exceeds the predetermined upper limit or is less than the lower limit, and the sensor for determining the rotational speed of the engine 110 is not normally operating. In particular, the second condition is not satisfied when the sensor for determining the rotational speed of the engine 110 is not normally operating, or a first sensor that detects the position of the first motor 120 is not normally operating. For example, when there is no signal generated from the first sensor even the first motor 120 and the engine 110 connected thereof are rotating, the stop-control-entry determining unit 310 considers that the first sensor is not normally operating and determines that the second condition is not satisfied. The second condition is on the engine 110 rotational energy recovery of the first motor 120 considering the engine 110, the battery protection, or the energy recovery efficiency, and when the stop-control-entry determining unit 310 does not satisfy the second condition, it is considered that the rotational energy recovery is impossible or inappropriate, so thus the engine-stop control is not entered.

The stop-control-entry determining 310 allows to enter the stop control when both first condition and the second condition are satisfied.

When the first condition and the second condition are satisfied, and in the case of the stop-control-entry determining unit 310 is entered to the engine stop control, the torque determining unit 320 may determine the rotational speed of the engine 110 through the detection result of at least one sensor, and based on the determined present rotational speed and a predetermined first target rotational speed, a negative torque is determined and apply to the first motor 120.

In this case, the rotational speed of the engine 110 may be determined by a second sensor, for example, which detects the crankshaft rotation of the engine 110. On the other hand, the engine 110 and the first motor 20 always rotate together so that the rotational speed of the engine 110 may be determined by the rotational speed of the first motor 120. Accordingly, the rotational speed of the engine 110 may be determined on the basis of the detection result of the first sensor (e.g., resolver) that detects the rotor position of the first motor. The first sensor has an excellent resolution and accuracy at a low speed than the second sensor and may obtain higher reliability compared to the case in which the rotational speed of the engine 110 is determined based on the detection result of the first sensor. Accordingly, it is appropriate to determine the rotational speed of the engine 110 by considering the detection result of the first sensor in priority, and in this case, the detection result of the second sensor may be utilized in a supplemental manner, in the case of a malfunction of the first sensor.

In addition, the torque determining unit 210 may be predict the reverse rotation based on the rotational speed of the engine 110. To be more specific, the reverse rotation of the engine 110 is predicted based on the present angular acceleration and the predetermined target angular acceleration, and in the case of the reverse rotation is predicted, the feedback torque for the target behavior satisfaction of the engine 110 may be applied to the first motor 120. In this case the target behavior may be defined as a state that the angular acceleration is less than or equal to the target angular acceleration, and the feedback torque applied to the first motor 120 may be a positive torque in the same direction as the rotational direction of the engine 110.

On the other hand, in the engine stop control, by using the first motor 120 instead of a motor, which is connected to the engine 110, a belt, and pulley, the difference rotational speed of the motor between the rotational speed of the motor, due to the elastic deformation and slip of the belt, and the rotational speed of the engine 110 may be reduced. Accordingly, the matching rate of the rotational speed between the first motor 120 and the engine 110 may be improved and thus may obtain the nearest value to the rotational speed of the actual engine 110 compared to the case where the rotational speed of the engine 110 determined through the detection result of the first sensor. When the reliability of a rotational speed determination value of the engine 110 is poor, it is necessary to lower the torque applied value in preparation for the reverse rotation of the engine 110 due to an unexpected value, although a larger amount of charging can be obtained. However, as the reliability of the determination value as described above is improved, a larger amount of torque may be applied, thereby efficiently performing the engine stop control. In addition, the amount of charging may further increase accordingly, and the vibration during the engine stop process may further reduced.

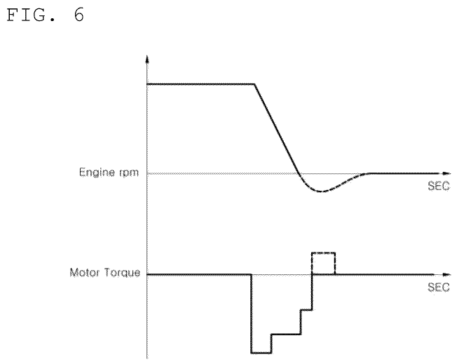

A detailed description of the negative torque being determined and predicting the reverse rotation and response thereof may be explained with reference to FIGS. 4 and 5 in the following.

FIG. 4 is a diagram describing an example of a form in which an engine stop control is performed according to an embodiment of the present disclosure.

Referring to FIG. 4, in the graph, the horizontal axis represents the time, and the vertical axes represent an engine stop request, the rotational speed of the engine 110, and the torque of the first motor 120, respectively. When the engine stop request is generated, the stop-control-entry determining unit 310 determines the first condition and the second condition and may apply the negative torque to the first motor 120 if both the first condition and the second condition are satisfied. As the negative torque is applied, the torque of the engine rotation direction and the reverse direction is outputted through the first motor 120, and rotational speed of the engine 110 may be reduced due to the output torque.

In this case, the negative torque applied to the first motor 120 through the torque determining unit 320 may be determined based on the rotational speed of the engine 110 and the predetermined first target rotational speed. Here, the rotational speed of the engine 110, as described in FIG. 3, may be determined based on the detection result of the first sensor and the second sensor. In addition, the first target rotational speed is the rotational speed in which the engine 110 does not reversely rotate and may be 0 rpm, for instance. As the value is large, the possibility of being reversely rotated is lowered, and increase the stop control efficiency as the value is small.

On the other hand, the negative torque may be determined to correspond to an absolute value of a difference between the rotational speed of the engine and a target rotational speed. Accordingly, as represented in a graph of FIG. 4, the torque gradient of the first motor 120 in the section in which the rotational speed of the engine 110 is high is steeper than the slope in the section in which the rotational speed of the engine 110 is relatively low. As the negative torque is determined as above, in the section in which the risk of being reversely rotated is low due to the high rotational speed of the engine 110, the rotational speed of the engine 110 may be rapidly reduced, and in the section in which the risk of being reversely rotated is high due to the low rotational speed of the engine 110, the rotational speed reduction rate of the engine 110 may be reduced. In addition, the negative torque, in this case, may be determined as the maximum charging torque that the first motor 120 can output for each of a plurality of sections of the difference between the engine 110 rotation speed and the first target rotation speed.

In addition, the negative torque may be determined by considering at least one of a predetermined maximum value or a predetermined variance limit per hour. For example, when the negative torque once determined according to the difference between the rotational speed of the engine 110 and the first target rotational speed exceeds a predetermined maximum value or exceeds the variance limit per hour, a maximum value, a value that satisfies the limit of variation per hour, or may be determined to have the same value as the previous negative torque (i.e., ignore the present value). Accordingly, the control errors due to the noise and the like may be mitigated.

Meanwhile, in the section where the rotational speed of the engine 110 reaches 0 rpm, the torque of the first motor 120 increases in the positive direction to avoid the reverse rotation, and the detailed description is described below with reference to FIG. 5.

FIG. 5 is a diagram for describing an example of a form in which engine reverse rotation prevention control is performed according to an embodiment of the present disclosure.

Referring to FIG. 5, a graph is expressed in which the vertical axis is the rotational speed of the engine 110, and the horizontal axis is time. When the engine stop control is entered, the rotational speed of the engine 110 is rapidly reduced as indicated by a solid line. In this case, there is a risk of reverse rotation as the rotational speed of the engine 110 falls below zero “0” rpm due to the high angular acceleration of the engine 110. To avoid the risk, the torque determining unit 320 predicts the reverse rotation of the engine based on the angular acceleration of the engine 110 and the predetermined target angular acceleration, and when the reverse rotation of the engine is predicted, the feedback torque is applied to the first motor 120 so that the angular acceleration of the engine 110 is less than or equal to the target angular acceleration.

In this case, the angular acceleration of the engine 110 may be determined based on the detection result of the aforementioned first sensor and the second sensor, and the target angular acceleration may be preset to correspond to the rotational speed of the engine 110 considering the engine 110 being reversely rotated. For example, when the rotational speed of the engine 110 is 300 rpm, the corresponding target angular acceleration may be 3000 rpm/s.

The angular acceleration of the engine 110 exceeds the target angular acceleration corresponding to the rotational speed of the engine 110, the torque determining unit 320 may predict that there is the reverse rotation, and in this case, the feedback torque is applied to the first motor 120.

Due to the application of the feedback torque, the torque of the first motor 120 gradually increases in the positive direction, and thus, as shown through the dotted line of FIG. 5, the slope of the rotational speed of the engine 110 is flattened, thereby reducing the possibility of reverse rotation.

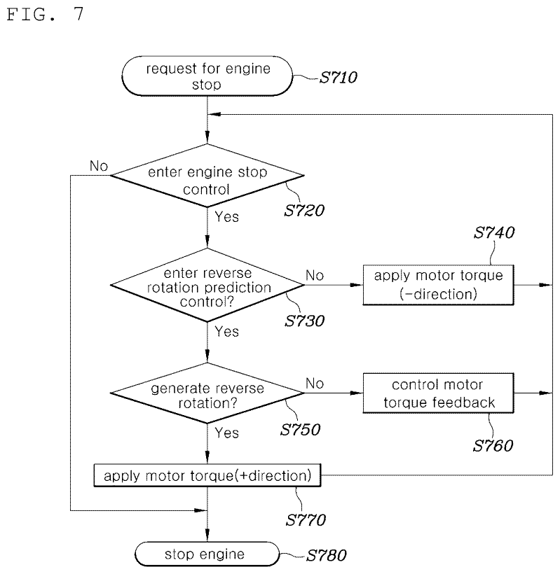

Meanwhile, a countermeasure in the case reverse rotation occurs despite the above-described avoiding the reverse rotation control is be described below with reference to FIG. 6.

FIG. 6 is a diagram for describing an example of a form in which engine reverse rotation correspondence control is performed according to an embodiment of the present disclosure.

Referring to FIG. 6, a graph is shown in which the horizontal axis represents the time, and the vertical axes represent the rotational speed of the engine 110 and the first motor torque command, respectively. When the rotational speed of the engine 110 is less than the second target rotational speed, the torque determining unit 320 may apply the torque to the first motor 120 so that the rotational speed of the engine 110 satisfies the second target rotational speed. In this case, the second target rotational speed may be set to be the same as the above-described first target rotational speed. For example, it may be set to 0 rpm. In addition, in some cases, it may be set to have a value greater than 0 rpm considering the control error and stability.

When the rotational speed of the engine 110 is less than the second target rotational speed, the torque determining unit 320 may determine that there is a reverse rotation. The reverse rotation may be terminated by applying the positive torque to the first motor 120 immediately after the determination. In addition, as the motor for performing the engine stop control is configured like the first motor, it is advantageous for recovery compared to the case where it is connected to the engine 110 through the belt and the pulley.

The engine stop control described so far is summarized in a flowchart as shown in FIG. 7.

Referring to FIG. 7, first, when the stop request is generated (S710), the stop-control-entry determining unit 310 may determine whether to enter the engine stop control based on the first condition and the second condition (S720). When the first condition and the second condition are satisfied and the engine stop control is entered (Yes in S720), the torque determining unit 320 may predict the reverse rotation of the engine 110 based on the angular acceleration of the engine 110 determined through the first sensor and the second sensor and the predetermined target angular acceleration (S730). In the case of the reverse rotation is not predicted (No in S730), the torque determining unit 320 may apply the negative torque determined based on the rotational speed of the engine 110 and the predetermined first target rotational speed to the first motor 120 (S740). When the reverse rotation is predicted (Yes in S730) but it is determined that the reverse rotation has not taken place (No in S750), the torque determining unit 320 may apply the feedback torque to the first motor 120 so that the angular acceleration of the engine 110 is less than or equal to the target angular acceleration in order to avoid the reverse rotation (S760). When it is determined that the reverse rotation has taken place (Yes in S750), the torque determining unit 320 may apply the positive torque to the first motor 120 that allows the engine 110 to satisfy the predetermined second target rotational speed in response to the reverse rotation (S770). Thereafter, when the engine start is stopped, the engine stop control is terminated (S780).

According to various embodiments of the present disclosure as described above, the motor torque for the rotational energy recovery may be improved through controlling the engine stop during the engine stop process.

Therefore, the amount of battery charge may be increased, thereby improving fuel efficiency, allowing the engine to be stopped quickly, and reducing the vibration during the engine stop process.

In particular, by predicting the reverse rotation of the engine more accurately, the reverse rotation may be mitigated while improving the efficiency of the engine stop control.

The present disclosure mentioned in the foregoing description may be implemented as code that can be written to a computer-readable recording medium and can thus be read by a computer system. The computer-readable medium may include all kinds of recording devices in which data readable by a computer system is stored. Examples of computer-readable medium includes hard disk drive (HDD), solid state disk (SSD), silicon disk drive (SDD), ROM, RAM, CD-ROM, magnetic tape, floppy disk, optical data storage device, and the like. Therefore, the above embodiments are therefore to be construed in all aspects as illustrative and not restrictive. The scope of the present disclosure should be determined by the appended claims and their legal equivalents, not by the above description, and all changes coming within the meaning and equivalent range of the appended claims are intended to be embraced therein.

What is claimed is:

1. A method for controlling an engine stop of a hybrid electric vehicle, the method comprising:
determining, when an engine stop request is generated, whether a first condition for stopping an engine and a second condition for an engine rotational energy recovery of a motor directly connected to the engine are satisfied;
applying, when the first condition and the second condition are satisfied, a negative torque to the motor, wherein the negative torque is determined based on a rotational speed of the engine and a predetermined first target rotational speed;
predicting a reverse rotation of the engine based on the rotational speed of the engine; and
when the reverse rotation is predicted, applying a feedback torque for satisfying a target behavior of the engine to the motor.

2. The method according to claim 1, wherein the rotational speed of the engine is determined based on a detection result of a first sensor detecting a position of a rotor of the motor.

3. The method according to claim 2, wherein the rotational speed of the engine is determined by further considering a detection result of a second sensor detecting a crankshaft rotation of the engine.

4. The method according to claim 1, wherein the negative torque is determined to correspond to an absolute value of a difference between the rotational speed of the engine and the target rotational speed.

5. The method according to claim 4, wherein the negative torque is determined by considering at least one of a predetermined maximum value and a predetermined variance limit per hour.

6. The method according to claim 1, wherein predicting the reverse rotation of the engine comprises: predicting an occurrence of the reverse rotation of the engine based on a predetermined target angular acceleration to correspond to the rotational speed of the engine considering the occurrence of the reverse rotation of the engine and the angular acceleration according to changes in the rotational speed of the engine.

7. The method according to claim 1, wherein whether the first condition is satisfied is determined based on at least one of an engine clutch state, a powertrain mode, or whether a fuel injection request is generated.

8. The method according to claim 1, wherein whether the second condition is satisfied is determined based on at least one of the rotational speed of the engine, a battery state, or whether a sensor detecting the rotational speed of the engine is normally operating.

9. The method according to claim 1, further comprising: when the rotational speed of the engine is less than a predetermined second target rotational speed, applying a positive torque to the motor so that the rotational speed of the engine is satisfied with the predetermined second target rotational speed.

10. A non-transitory computer-readable recording medium having a program recorded thereon, the program to direct a processor to perform acts of:
determining, when an engine stop request is generated, whether a first condition for stopping an engine of a hybrid vehicle and a second condition for an engine rotational energy recovery of a motor directly connected to the engine are satisfied;
applying, when the first condition and the second condition are satisfied, a negative torque to the motor, wherein the negative torque is determined based on a rotational speed of the engine and a predetermined first target rotational speed;
predicting a reverse rotation of the engine based on the rotational speed of the engine; and
when the reverse rotation is predicted, applying a feedback torque for satisfying the target behavior of the engine to the motor.

11. A hybrid electric vehicle comprising:
an engine;
a motor directly connected to the engine; and
a control unit configured to:
determine, when an engine stop request is generated, whether a first condition for stopped the engine and a second condition for an engine rotational energy recovery of the motor are satisfied,
apply, when the first condition and the second condition are satisfied, a negative torque to the motor, wherein the negative torque is determined based on a rotational speed of the engine determined by a detection result of at least one sensor and a predetermined first target rotational speed,
predict an occurrence of reverse rotation of the engine based on the rotational speed of the engine, and
apply, when the occurrence of the reverse rotation is predicted, a feedback torque for satisfying a target behavior of the engine to the motor.

12. The hybrid electric vehicle according to claim 11, wherein the at least one sensor includes a first sensor configured to detect a position of a rotor of the motor, and the rotational speed of the engine is determined based on a detection result of the first sensor.

13. The hybrid electric vehicle according to claim 12, wherein the at least one sensor includes a second sensor configured to detect a crankshaft rotation of the engine, and the rotational speed of the engine is determined by further considering a detection result of the second sensor.

14. The hybrid electric vehicle according to claim 11, wherein the negative torque is determined to correspond to an absolute value of a difference between the rotational speed of the engine and a target rotational speed.

15. The hybrid electric vehicle according to claim 14, wherein the negative torque is determined by considering at least one of a predetermined maximum value or a predetermined variance limit per hour.

16. The hybrid electric vehicle according to claim 11, wherein the control unit is configured to predict an occurrence of the reverse rotation of the engine based on a predetermined target angular acceleration to correspond to the rotational speed of the engine considering the occurrence of the reverse rotation of the engine and the angular acceleration according to changes in the rotational speed of the engine.

17. The hybrid electric vehicle according to claim 11, wherein whether the first condition is satisfied is determined based on at least one of an engine clutch state, a powertrain mode, or whether a fuel injection request is generated.

18. The hybrid electric vehicle according to claim 11, wherein whether the second condition is satisfied is determined based on at least one of the rotational speed of the engine, a battery state, or whether the at least one sensor is normally operating.

19. The hybrid electric vehicle according to claim 11, wherein when the rotational speed of the engine is less than a predetermined second target rotational speed, the control unit is configured to apply a positive torque to the motor so that the rotational speed of the engine is satisfied with the predetermined second target rotational speed.
